(19) United States
(12) Patent Application Publication
(10) Pub. No.: US 2004/0142708 A1
(43) Pub. Date: Jul. 22, 2004

(54) Communication apparatus and communication system

(75) Inventors: Yukinori Asada, Yokohama (JP); Toshio Kamimura, Yokohama (JP)

Correspondence Address: McDermott, Will & Emery, 600, 13th Street, N.W., Washington, DC, 20005-3096, US

(73) Assignee: Hitachi, Ltd.

(21) Appl. No.: 10/448,387

(22) Filed: May 30, 2003

(30) Foreign Application Priority Data
Jan. 17, 2003 (JP) 2003-009002

(51) Int. Cl. H04M 1/00; H04B 1/38; H04Q 7/20

(52) U.S. Cl. 455/466; 455/566; 455/556.1

(57) ABSTRACT

A communication apparatus is disclosed which communicates with a second communication apparatus via a base station. The communication apparatus includes an incoming call notice receiving unit for receiving an incoming call notice including picture transmission information signaling that the second communication apparatus is planning to send a picture via the base station; a picture receiving unit for receiving the picture sent from the second communication apparatus; and a display unit for displaying the picture received by the picture receiving unit. The picture transmission information has identification information for identifying the type of the picture to be sent by the second communication apparatus, and the display unit displays the picture type along with the picture.

### BACKGROUND OF THE INVENTION

The present invention relates to a communication apparatus capable of sending and receiving pictures and to a communication system configured using such apparatuses.

Japanese Published Unexamined Patent Application No. 2002-152332 discloses a communication system which allows a sending terminal to send a picture of the calling party to a receiving terminal so as to let the receiving party identify the calling party without receiving the calling party's telephone number before a call may be established.

### SUMMARY OF THE INVENTION

One disadvantage of the invention disclosed in the above application is that the receiving party is unable to determine whether the picture being sent is a real-time picture, a previously stored picture, or someone else's picture. Another disadvantage is that a picture appearing abruptly on the receiving terminal without notice can be offensive to the receiving party, inconveniencing the latter.

In solving the foregoing and other problems of the related art and according to one aspect of the invention, there is provided a communication apparatus for communicating with a second communication apparatus via a base station, the communication apparatus comprising: an incoming call notice receiving unit for receiving fan incoming call notice including picture transmission information signaling that the second communication apparatus is planning to send a picture via the base station; a picture receiving unit for receiving the picture sent from the second communication apparatus; and a display unit for displaying the picture received by the picture receiving unit. The picture transmission information has identification information for identifying the type of the picture to be sent by the second communication apparatus, and the display unit displays the picture type along with the picture.

The communication apparatus may preferably comprise a storage unit for storing telephone numbers of a plurality of communication apparatuses. If the telephone number of the second communication apparatus is not stored in the storage unit, then the display unit may give a display requesting a decision whether or not to display the picture received by the picture receiving unit.

According to another aspect of the invention, there is provided a communication apparatus for communicating with a second communication apparatus via a base station, the communication apparatus comprising: a picture sending unit for sending a picture; an outgoing call request sending unit for sending to the base station an outgoing call request including picture transmission information asking whether the picture sending unit may send the picture to the second communication apparatus; and a control unit which, upon receipt of reception refusal information from the second communication apparatus signaling a refusal to receive the picture, causes the picture sending unit not to send the picture.

### BRIEF DESCRIPTION OF THE DRAWINGS

Further objects and advantages of this invention will become apparent upon a reading of the following description and appended drawings in which:

FIG. 1 is a block diagram of a mobile telephone embodying the invention;

FIG. 2 is an explanatory view outlining how communication takes place between the mobile telephones of the invention and a base station;

FIG. 3 is a flowchart showing a sequence of call-originating steps performed by the inventive mobile telephone;

FIG. 4 is a flowchart indicating a sequence of call-receiving steps carried out by the inventive mobile telephone;

FIGS. 5A and 5B are schematic views depicting typical screen displays of the inventive mobile telephone; and

FIGS. 6A and 6B are schematic views illustrating other typical screen displays of the inventive mobile telephone.

### DETAILED DESCRIPTION OF THE PREFERRED EMBODIMENTS

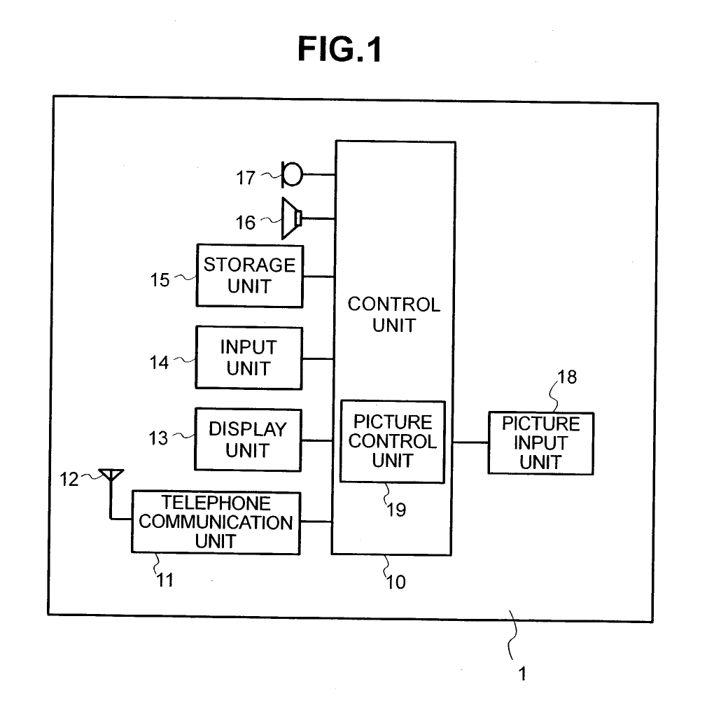

FIG. 1 is a block diagram of a mobile telephone embodying the invention. The mobile telephone is but one example of the communication apparatus embodying the invention and is not limitative thereof. Alternatively, the invention may be practiced in the form of a fixed telephone, a PDA (personal digital assistant), or any other suitable communication device.

In FIG. 1, reference numeral 1 stands for a mobile telephone, 10 for a control unit such as a CPU effecting diverse controls, 11 for a telephone communication unit for sending and receiving phone calls, 12 for an antenna, 13 for a display unit such as an LCD (liquid crystal display), and 14 for an input unit having dial keys for entering numbers and characters as well as function keys for moving a cursor and selecting necessary functions. As an alternative, the display unit 13 may be implemented as a touch-sensitive display that may be touched by the user with fingertips or with a stylus for character input and functional selection. This allows a user not familiar with key manipulations to carry out input operations with ease.

Reference numeral 15 denotes a storage unit such as a RAM for storing data. The storage unit 15 may be a removable storage medium such as an IC card. Reference numeral 16 stands for a speaker, 17 for a microphone, 18 for a picture input unit such as a camera, and 19 for a picture control unit for controlling picture displays. The picture control unit 19 controls not only the pictures input from the picture input unit 18 but also the pictures entered through the telephone communication unit 11. Although the picture control unit 19 is shown to be incorporated in the control unit 10 in FIG. 1 this is not limitative of the invention. Alternatively, the picture control unit 19 may be furnished independently of the control unit 10.

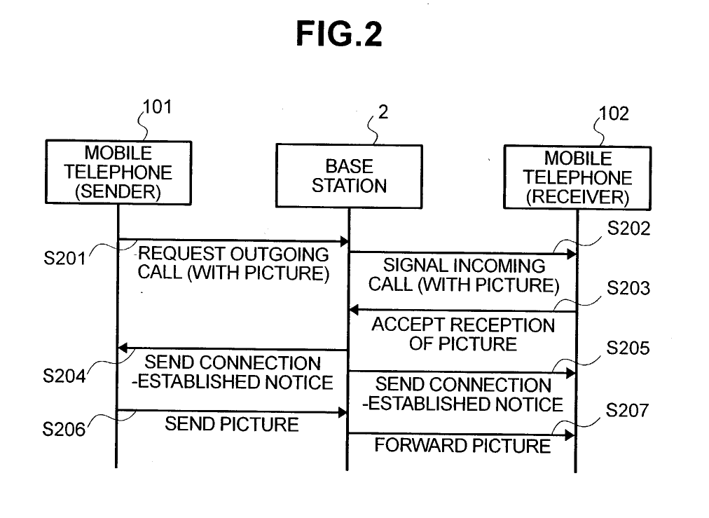

How the mobile telephone 1 is used for communication will now be described with reference to FIG. 2. It is assumed here that a call-originating (sender) mobile telephone and a call-receiving (receiver) mobile telephone are designated by reference numerals 101 and 102 respectively.

In step S201 of FIG. 2, the mobile telephone 101 sends an outgoing call request to the base station 2 through the telephone communication unit 11 and antenna 12. When planning to send a picture, the mobile telephone 101 furnishes the request with picture transmission information signaling that it plans to send the picture. The information includes format information indicating the resolution and compression format of the picture to be sent, as well as identification information identifying the picture to be sent as a real-time picture or a stored picture. In step S202, the base station 2 receives the outgoing call request and sends accordingly an incoming call notice together with the picture transmission information to the mobile telephone 102. In step S203, the mobile telephone 102 receives the incoming call notice, decides whether to display the picture to be sent from the mobile telephone 101, and sends the decision to the base station 2. In the example of FIG. 2, the decision to accept reception of the picture is shown returned to the base station 2 in step S203.

Upon receipt of the decision to accept picture reception from the mobile telephone 102, the base station 2 may notify the mobile telephone 101 thereof or may only do so in case the mobile telephone 102 has refused the reception of the picture. In this example, the base station 2 gives no notice to the mobile telephone 101; the notice is arranged to be sent to the mobile telephone 101 only if the mobile telephone 102 refuses to receive the picture.

When connection is established between the mobile telephones 101 and 102, the base station 2 sends a connection-established notice to the mobile telephones 101 and 102 in steps S204 and S205 respectively. In step S206, the mobile telephone 101 sends the picture to the base station 2. In step S207, the base station 2 forwards the received picture to the mobile telephone 102. The mobile telephone 102 may sound a ring tone upon picture reception and display the picture sent from the mobile telephone 101.

It is possible to send not only pictures but also pieces of music or audio information such as voice messages. For example, when a picture is taken by the picture input unit 18, the ambient sound may also be picked up by the microphone 17 and transmitted along with the picture. The picture and sound to be sent are not limited to those identifying the calling party. In commercial applications, suppliers of produces and services may send pictures and sounds advertising their wares. On the receiving side, such pictures and sounds may or may not be received and responded to through an appropriate selection procedure based on the receiving party's interests.

When the mobile telephone 101 sends pictures or sounds, its owner is billed for the amount of the data constituting what has been sent. Alternatively, the carrier involved may take over the charges on the mobile telephone 101 for the picture transmission by sending advertisement information to the telephone 101 when the latter makes an outgoing call request. As another alternative, when the mobile telephone 102 signals acceptance of picture reception, the base station 2 may request the mobile telephone 101 to receive advertisements. As a further alternative, before making an outgoing call request, the mobile telephone 101 may be requested to receive advertisements. In this case, the amount of the data constituting the picture or sound to be sent may be determined in proportion to the period of time in which the calling party has viewed the advertisement or in accordance with the content of the advertisement received.

For example, if a user watches a 15-second advertisement, the picture or sound being currently picked up may be sent for 15 seconds. A user viewing an advertisement A may be allowed to send the picture or sound for 10 second, and another user taking a look at an advertisement B may be entitled to a 15-second picture or sound transmission. In this manner, the user may select different types of advertisements to watch in keeping with his or her needs.

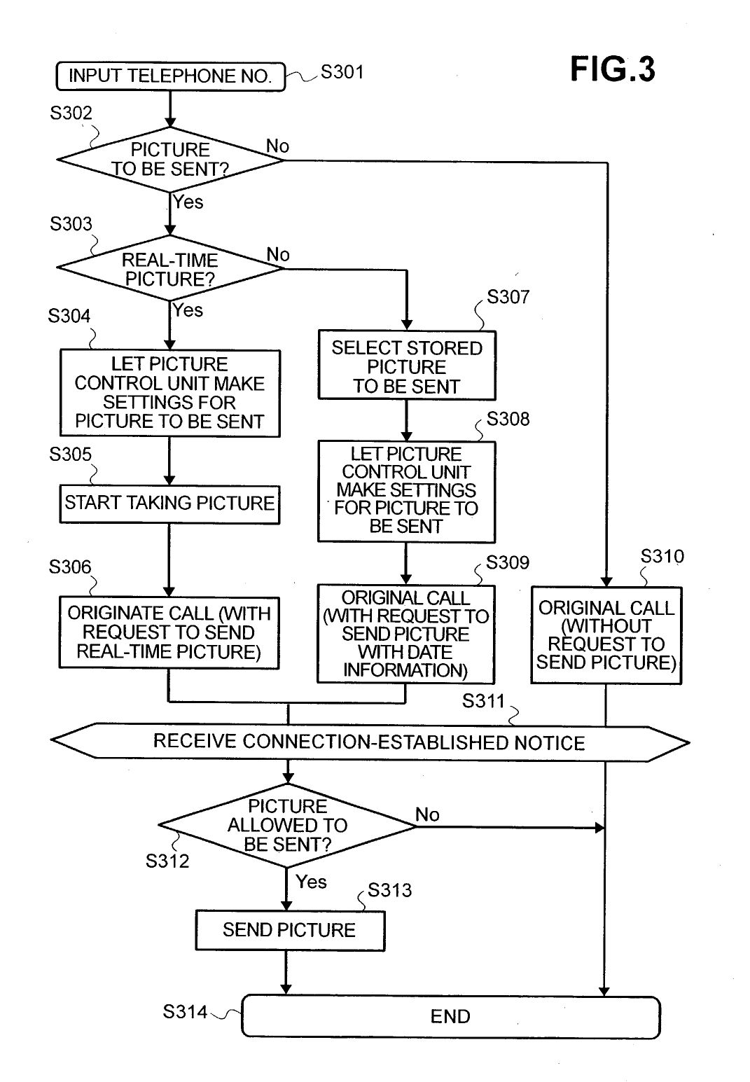

FIG. 3 is a flowchart showing a sequence of call-originating steps performed by the mobile telephone 101. The control unit 10 carries out the steps that are described below, in accordance with a program held in the storage unit 15. This program may be preinstalled before the mobile telephone 101 is marketed, or may be installed by the user after his or her purchase of the mobile telephone 101. If the user is to install the program following the purchase of the mobile telephone 101, the user first gains access to a server where the program is stored, gets the program downloaded, and enters the downloaded program into the storage unit 15.

In step S301 of FIG. 3, the user either inputs the telephone number of the receiving party's mobile telephone through the input unit 14 or selects the receiving party's telephone number or name from phone book data in the storage unit 15. The phone book data are constituted primarily by combinations of telephone numbers with associated names. Illustratively, individuals' telephone numbers, names, addresses, the names of the companies they work for, and their e-mail addresses may be stored as phone book data. In step S302, the user determines whether to send a picture using the input unit 14. If picture transmission is selected in step S302, then step S303 is reached and the user determines whether to send a picture taken in real time or to transmit a previously stored picture from the storage unit 15. Step S301 may alternatively be carried out after steps S302 and S303 have been performed.

If it is decided to send a real-time picture, then the picture control unit 19 makes necessary settings for picture transmission in step S304, and the picture input unit 18 starts taking a picture in step S305. In step S306, the control unit 10 sends a picture transmission request including identification information identifying the picture as a real-time picture. Making the necessary settings for picture transmission involves selecting and establishing the compression format, resolution, and transfer rate for the picture to be sent, as well as attachment of sound if any to the picture. The picture control unit 19 may establish the picture to be sent in accordance with the settings input by the user through the input unit 14. Alternatively, the picture settings may be stored beforehand as part of the phone book data in the storage unit 15, so that when the user selects a destination from the phone book data, the corresponding settings may be retrieved from the phone book data and established automatically. The advance storage of picture settings as part of the phone book data eliminates the need for the user to make necessary settings every time a picture is to be sent, which affords an appreciable convenience to the user.

If it is decided to send a previously stored picture retrieved from an appropriate storage location, then step S307 is reached. In step S307, the control unit 10 reads a picture list from the storage unit 15 and displays the list on the display unit 13, allowing the user to select a desired picture from the displayed picture list. In step S308, the control unit 10 makes necessary format settings for the picture to be sent. With the settings completed, step S309 is reached in which the control unit 10 sends a picture transmission request together with identification information identifying the picture as a previously stored picture. Typical identification information is date information attached to certain bits of the picture to be sent.

If it is decided not to send a picture in step S302, then step S310 is reached in which the control unit 10 originates a call without a picture transmission request. In this step, the receiving mobile telephone 102 usually emits a ring tone. If connection is established in step S311 and if the mobile telephone 102 signals its readiness to receive the picture (“Yes” in step S312), then the control unit 10 sends the picture in step S313. If the mobile telephone 102 signals its refusal to receive the picture (“No” in step S312), then the control unit 10 will not send the picture.

With this embodiment, as described, the call-originating mobile telephone first sends an outgoing call request along with the attached information signaling that it plans to send a picture. The picture is sent only if the receiving mobile telephone signals its readiness to receive the picture. This arrangement prevents the wasteful use of communication circuits over which pictures are conventionally transmitted regardless of the receiving mobile telephone being ready to accept picture transmission.

This embodiment regards as a real-time picture the picture taken after the telephone number is input and before an outgoing call request is made. However, this is not limitative of the invention. Alternatively, the outgoing call request may be accompanied by identification information signaling that the calling party plans to send a real-time picture. After connection is established, the calling party may take the picture and send it to the receiving party. This makes it possible for the receiving party to receive the most recent picture, i.e., the one taken immediately before the transmission.

Although this embodiment prompts the user to determine whether to take a real-time picture at every picture transmission, this is not limitative of the invention. Alternatively, the decision whether to take a real-time picture may be set in advance on the mobile telephone and the setting may be retained thereafter. This spares the user the trouble of making a decision at every picture transmission and thereby enhances the user's convenience.

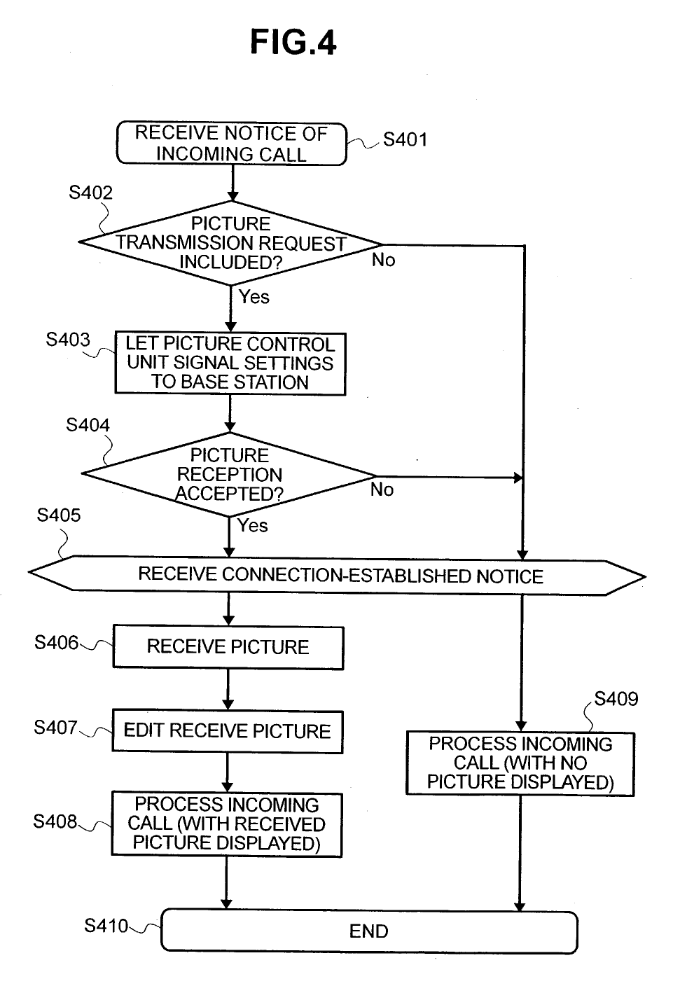

FIG. 4 is a flowchart indicating a sequence of call-receiving steps carried out by the mobile telephone 102. In step S401, an incoming call notice is received. In step S402, a check is made to see if a picture transmission request is included. If no picture transmission request is judged to be included, the incoming call is normally processed without picture display in step S409. If a picture transmission request is judged to be included, then step S403 is reached and the picture control unit 18 decides whether to receive the picture and sends setting information to the base station 2, the setting information being representative of the decision whether to receive the picture. If there is no information to signal or if there is no need for any notice to send, step S403 may be skipped.

If it is decided not to receive the picture (“No” in step S404), then a connection-established notice is received in step S405 and the incoming call is normally processed in step S409 with the calling party's telephone number appearing on the display unit 13. If it is decided to receive the picture (“Yes” in step S404), then the picture is received in step S406 and the received picture is edited by the picture control unit 19 in step S407. The editing involves establishing the resolution, transfer rate, display size, and other necessary settings for the picture. In step S408, the received picture is displayed with the ring tone reproduced concurrently.

In an alternative arrangement, a picture sent by any one of the individuals whose telephone numbers are stored beforehand in the phone book data in the storage 15 may be received and displayed without the user's instruction. In this case, an attempt to send a picture by any calling party whose telephone number is not stored may be arranged to prompt display of a message such as “Picture is being received. Do you want it displayed?” on the display unit 13. Only when the user gives explicit permission for picture display, can the picture be displayed. This arrangement protects the user from viewing offensive pictures being sent by unscrupulous parties. It is also possible for the user to specify in advance that pictures from certain individuals be blocked from being displayed or received. These features further improve the user's convenience.

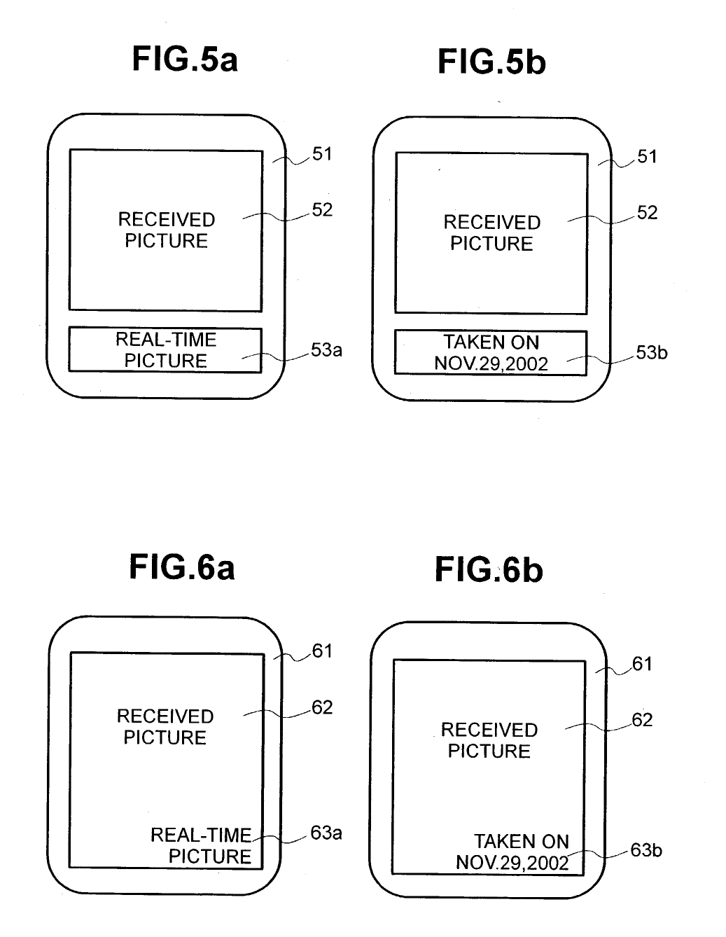

FIGS. 5A, 5B, 6A and 6B show typical screen displays of the mobile telephone. In FIGS. 5A and 5B, reference numeral 51 denotes a typical screen of the mobile telephone; reference numeral 52 represents a received picture; and reference numerals 53a and 53b each stand for a picture information display area for displaying information about the picture being received. The area 53a indicates what is received is a real-time picture, while the area 53b shows that the picture is a previously stored picture evidenced illustratively by a date of picture taking. In addition to the indication of a real-time picture or a stored picture, the areas 53a and 53b may display the calling party's name, telephone number, and geographical location if such a location is made known. Whereas the displays in FIGS. 5A and 5B are shown having the received pictures 52 displayed separately from the picture information display area 53a and 53b, this is not limitative of the invention. As an alternative, FIGS. 6A and 6B indicate screen displays where the received pictures 62 are overlaid with picture information display areas 63a and 63b.

These displays tell the receiving party whether the picture being received is a real-time picture. In a conventional setup where the picture being sent from the calling party is not a real-time picture, the receiving party is unable to identify the calling party by the received picture. This problem is circumvented by this embodiment allowing the user to know if the received picture is a real-time picture. The knowledge enables the user to respond to the incoming call with a sense of security.

It is also possible for the user to specify beforehand that the incoming call be accepted only upon receipt of a real-time picture and that in case of a stored picture transmission or no picture transmission, a message be sent to the calling party signaling the receiving party's refusal to respond or requesting transmission of a real-time picture. This arrangement allows the user to identify the calling party with confidence before responding, further enhancing the user's convenience.

As described, this embodiment of the invention enables the receiving mobile telephone to display a real-time picture during incoming call processing thereby allowing the receiving party to ascertain who is calling before deciding whether or not to respond. If the telephone terminal in use is not designed to display pictures or if the user is unwilling to display the received picture, the embodiment permits the user to make necessary settings for a refusal to display pictures. In commercial applications, the carrier involved may ask the calling party to view advertisements in exchange for free-of-charge uses of communication circuits.

Although the examples above have centered on the mobile telephones communicating with each other, this is not limitative of the invention. The invention may be applied just as advantageously to communications between a mobile telephone and a fixed telephone, as well as between fixed telephones. The invention thus offers a convenient, easy-to-use communication apparatus and a communication system configured using such apparatuses.

As many apparently different embodiments of this invention may be made without departing from the spirit and scope thereof, it is to be understood that the invention is not limited to the specific embodiments thereof except as defined in the appended claims.

What is claimed is:

1. A communication apparatus for communicating with a second communication apparatus via a base station, said communication apparatus comprising:
an incoming call notice receiving unit which receives an incoming call notice including picture transmission information signaling that said second communication apparatus is planning to send a picture via said base station;
a picture receiving unit which receives said picture sent from said second communication apparatus; and
a display unit which displays said picture received by said picture receiving unit;
wherein said picture transmission information has identification information for identifying the type of said picture to be sent by said second communication apparatus; and
wherein said display unit displays the picture type along with said picture.

2. A communication apparatus according to claim 1, wherein said identification information identifies said picture as either a real-time picture or a stored picture.

3. A communication apparatus according to claim 1, further comprising a storage unit which stores telephone numbers of a plurality of communication apparatuses;
wherein, if the telephone number of said second communication apparatus is not stored in said storage unit, then said display unit gives a display requesting a decision whether or not to display said picture received by said picture receiving unit.

4. A communication apparatus according to claim 1, further comprising:
a reception determining unit which determines whether or not to receive said picture depending on said picture transmission information; and
a sending unit which, if said reception determining unit has determined not to receive said picture, then sends to said base station information signaling a refusal to receive said picture.

5. A communication apparatus for communicating with a second communication apparatus via a base station, said communication apparatus comprising:
a picture sending unit for sending a picture;
an outgoing call request sending unit for sending to said base station an outgoing call request including picture transmission information asking whether said picture sending unit may send said picture to said second communication apparatus; and
a control unit which, upon receipt of reception refusal information from said second communication apparatus signaling a refusal to receive said picture, causes said picture sending unit not to send said picture.

6. A communication apparatus according to claim 5, wherein, if said reception refusal information is not received before the receipt of a notice from said base station signaling establishment of a communication circuit with said second communication apparatus, then said control unit causes said picture sending unit to send said picture.

7. A communication apparatus according to claim 5, wherein, upon receipt of reception acceptance information signaling that said second communication apparatus is ready to receive said picture, said control unit causes said picture sending unit to send said picture.

8. A communication apparatus according to claim 5,
wherein said picture transmission information has identification information for identifying said picture as either a real-time picture or a stored picture.

9. A communication apparatus having a telephone capability, comprising:
an input unit for inputting a telephone number;
a determination unit for determining whether or not to send a picture to a destination corresponding to said telephone number input by said input unit; and
a sending unit which, if said determination unit has determined to send said picture, then sends to said destination said picture along with identification information for identifying the sent picture either as a real-time picture or a stored picture.

10. A communication system for allowing a first communication apparatus and a second communication apparatus to communicate with each other via a base station; said communication system comprising:
(a) said first communication apparatus which comprises:
an outgoing call request sending means for sending to said base station an outgoing call request including picture transmission information signaling that said first communication apparatus is planning to send a picture to said second communication apparatus; and
a picture sending means for sending said picture; and
(b) said second communication apparatus which comprises:
an incoming call notice receiving means for receiving from said base station an incoming call notice including said picture transmission information signaling that said first communication apparatus is planning to send said picture;
a picture receiving means for receiving said picture sent from said first communication apparatus; and
a displaying means for displaying said picture received by said picture receiving means;
wherein said picture transmission information has identification information for identifying the type of said picture to be sent by said second communication apparatus; and wherein said displaying means displays the picture type along with said picture.
